(19) United States
(12) Patent Application Publication
(10) Pub. No.: US 2007/0223880 A1
(43) Pub. Date: Sep. 27, 2007

(54) Video playback apparatus

(75) Inventors: Ryosuke Ohtsuki, Osaka City (JP); Yuji Yamamoto City, Moriguchi (JP); Tatsuo Koga, Daito City (JP); Satoru Matsumoto, Izumi City (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi (JP)

(21) Appl. No.: 11/713,610

(22) Filed: Mar. 5, 2007

(30) Foreign Application Priority Data
Mar. 8, 2006 (JP) JP2006-061956

(51) Int. Cl. H04N 7/00

(52) U.S. Cl. 386/95

(57) ABSTRACT

A video playback apparatus informs a user of scene change. The video playback apparatus includes a feature extraction unit to extract feature scenes having audio/video content and a playback unit to replay feature scenes that have been extracted by the feature extraction unit. The playback unit further includes an identification information output unit that outputs information that identifies a feature scene being replayed.

### CROSS REFERENCE TO RELATED APPLICATIONS

This application claims priority based on 35 USC 119 from prior Japanese Patent Application No. P2006-061956 filed on Mar. 8, 2006, the entire contents of which are incorporated herein by reference.

### BACKGROUND OF THE INVENTION

1. Field of the Invention

The invention relates to a video playback apparatus that automatically generates and replays feature extraction scenes in audio/video content.

2. Description of Related Art

Technologies that extract and replay feature scenes such as images have been disclosed. Japanese Laid-Open Publication No. 2003-298981 describes a method of generating appropriate digest images according to categories of programs such as news, music, and sumo wrestling.

According to such methods, however, the extracted feature scenes are seamlessly generated and replayed. Therefore, a changing point of the generated scenes (so called “scene change”) is poorly recognizable by a user. This complicates the ability to search for a desired scene.

The invention provides a video playback apparatus that informs a user of scene changes when replaying digest images. This can be termed “digest playback.”

### SUMMARY OF THE INVENTION

An aspect of the invention provides a video playback apparatus, which includes a feature extraction unit to extract feature scenes in audio/video content; and a playback unit to replay the feature scenes that are extracted by the feature extraction unit. Further, the playback unit comprises an identification information output unit to output information for identification of a feature scene being replayed.

Another aspect of the invention provides a video playback method that extracts multiple feature scenes in audio/video content; replays the extracted feature scenes; and outputs information that identifies a feature scene being replayed.

### BRIEF DESCRIPTION OF THE DRAWINGS

FIG. 1 is a block diagram that shows a video playback apparatus according to an embodiment.

FIG. 2A and FIG. 2B are diagrams that explain a detection process for a designated peak point according to an embodiment.

FIG. 3 is a flowchart that shows a detection and recording process for a designated peak point according to an embodiment.

FIG. 4 is a diagram that shows an exemplary list of designated peak points.

FIG. 5 is a flowchart that shows a digest playback process according to an embodiment.

FIG. 6A and FIG. 6B are diagrams that show exemplary play lists according to an embodiment.

FIG. 7 is a flowchart that shows a digest playback process according to an embodiment.

FIG. 8 is a diagram that shows an exemplary progress display in digest playback according to an embodiment.

FIG. 9 is a diagram that shows another exemplary progress display in digest playback according to an embodiment.

FIG. 10 is a diagram that shows still another exemplary progress display in digest playback according to an embodiment.

### DETAILED DESCRIPTION OF EMBODIMENTS

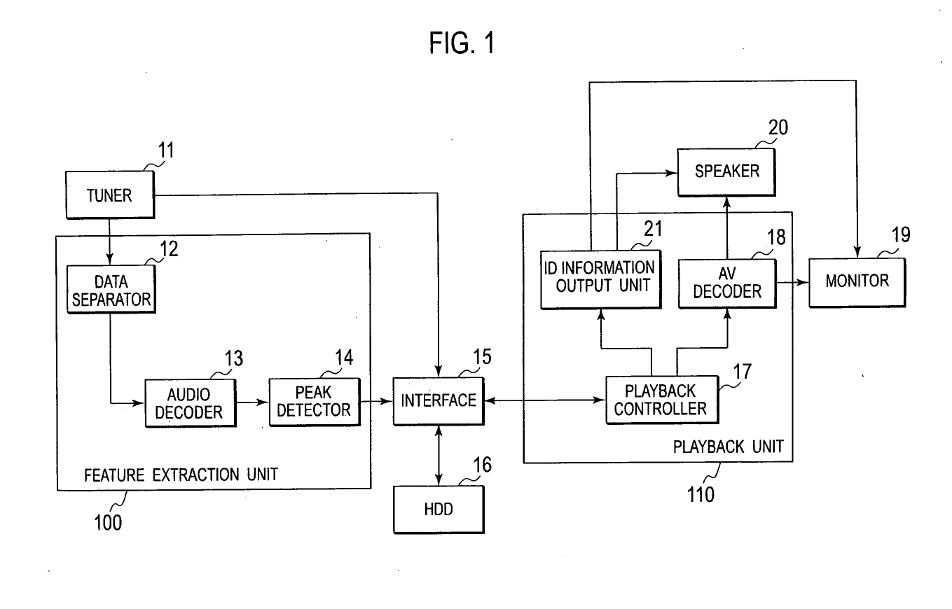

An embodiment of the invention is described with reference to the accompanying drawings. FIG. 1 is a diagram that shows the structure of a video playback apparatus according to an embodiment. This figure shows a video playback apparatus that primarily consists of tuner 11, data separator 12, audio decoder 13, peak detector 14, interface 15, storage device 16, playback controller 17, AV decoder 18, monitor 19, speaker20, ID information output unit 21, and a system controller (not shown in the figure). In addition, feature extraction unit 100 includes data separator 12, audio decoder 13 and peak detector 14, and playback unit 110 includes ID information output unit 21, AV decoder 18, and playback controller 17. HDD (Hard Disk Drive) is shown in FIG. 1 as storage device 16; however, the device is not limited to the example.

Tuner 11 detects and receives an audio/video broadcasting signal to demodulate the signal to an encoded audio/video signal such as for the MPEG2-TS (Moving Picture Experts Group 2 Transport Stream) format. Data separator 12 separates the encoded audio/video signal such as MPEG2-TS which is sent from tuner 11, into an encoded audio signal and an encoded video signal. Audio decoder 13 converts the encoded audio signal, which is separated by data separator 12, into an audio signal.

Peak detector 14 detects a peak location and its peak value where the strength of the audio signal output, which audio decoder 13 converts, attains its highest point within a set time period. In addition, peak detector 14 records the detected results as digest playback point information into storage device 16. The digest playback point indicates a scene that is used when playing a digest playback.

Interface 15 is an interface that records an encoded audio/video signal into storage device 16 and also reads an encoded audio/video signal from storage device 16. Additionally, interface 15 records digest playback point information that is generated by peak detector 14 into storage device 16 based on the control of peak detector 14. The digest playback point information also is read from storage device 16 based on the control of playback controller 17. Storage device 16 is a storage device that records an encoded audio/video signal.

Playback controller 17 obtains the total number of detected digest playback points based on digest playback point information stored in an HDD. Then, playback controller 17 generates information that includes a playback order of each digest playback point in the entire digest playback points and creates a play list comprising information including the playback order, the total number of the digest playback points, and each digest playback point information. Specified recorded parts, which are read from storage device 16 by playback controller 17 in accordance with the play list, are replayed with AV decoder 18. Also, the play list is sent to ID information output unit 21 by playback controller 17.

AV decoder 18 obtains an encoded audio/video signal, such as a MPEG2-TS format recorded signal, in storage device 16 and converts the signal into an audio signal and a video signal. Monitor 19, which includes a main screen and a sub screen, relays the video signal output for playback. The main screen displays a main video signal, and the sub screen is used as OSD (On Screen Display). Speaker 20 relays the audio signal output for playback.

Based on the play list created by playback controller 17, ID information output unit 21 controls display information for identification of digest playback points such as an order of the entire digest playback points on monitor 19 as OSD. Also, ID information output unit 21 controls output of the information from speaker 20 as an audio synthesis. In addition, the system controller, which is not shown in the figure, controls components of the video playback apparatus in an organized manner.

Next, a video recording process using the above structure of the video playback apparatus is explained. In this video playback apparatus, tuner 11 detects and receives an audio/video broadcasting signal to demodulate the signals to MPEG2-TS format. Data separator 12 receives the encoded audio/video signal and extracts an encoded audio signal. Audio decoder 13 converts the signal to an audio signal, and peak detector 14 detects a peak point and its peak value of the audio signal with a detection method as described later. The detected peak point and its peak value are sequentially recorded into storage device 16 through interface 15 as digest playback point information. A compressed signal, which is demodulated and compressed in tuner 11, also is recorded into storage device 16 through interface 15.

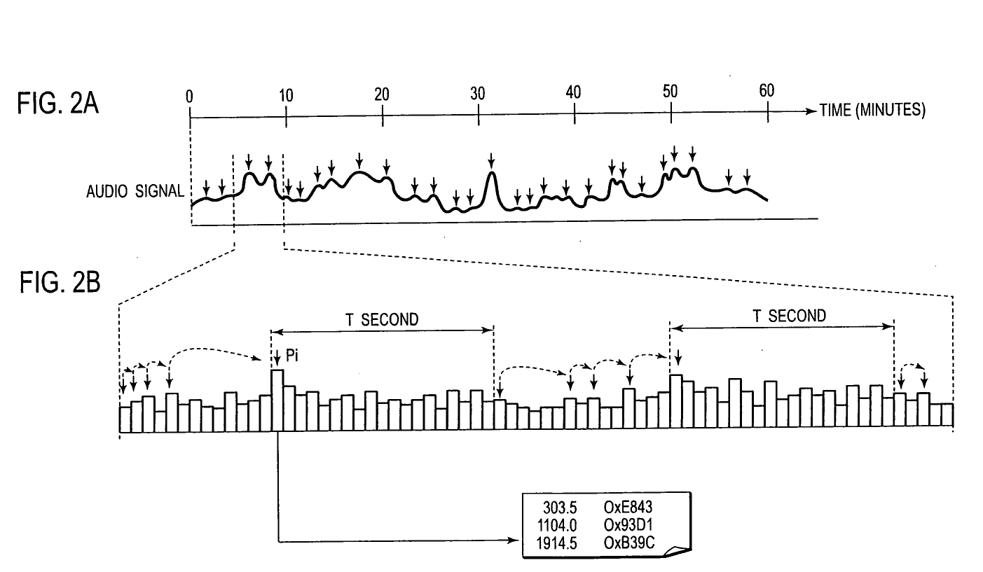

A recording process to detect a peak point with peak output strength value, by peak detector 14 is explained below. FIG. 2A shows a sound amplitude wave pattern, and FIG. 2B shows a quantized graph of FIG. 2A. In comparing values of the audio output strength in sequence from the start, if a power value of Pi is larger than other power values within a set time period T (e.g., twenty seconds) afterward, then the power value of Pi is determined as a feature point, and the location and the power value of Pi are recorded. That is, a certain peak output strength value is held and the peak value and the peak location are recorded if the peak value of the output strength is the largest value within a set time period T. Later in the same way, if larger power values than the power value of Pi are not found within a set time period T, then the power value of Pi is determined as the feature point, and the location and the power value of Pi are recorded.

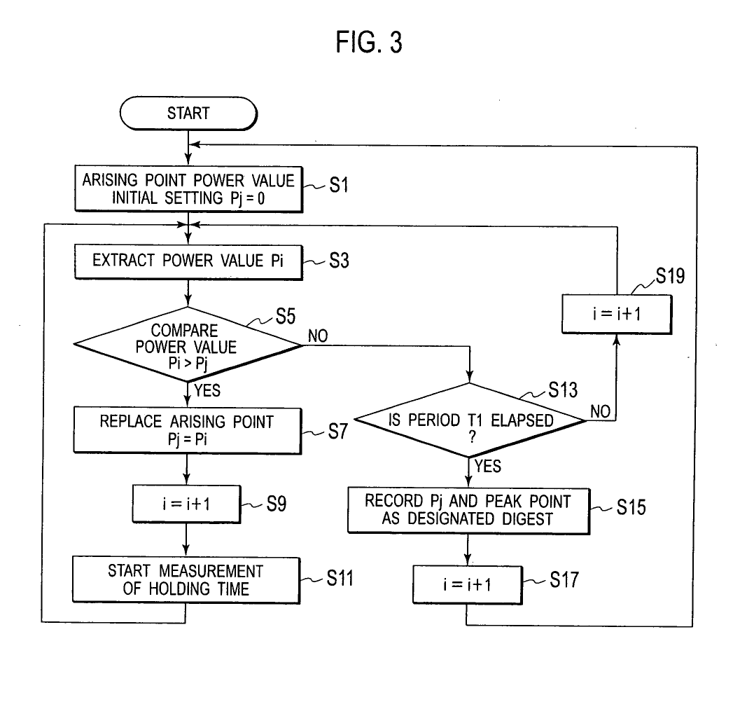

FIG. 3 is a basic flowchart showing power peak value detection and recording process by peak detector 14. The steps of this include: initializing a feature point power value Pj=0 (S1), extracting a power value of Pi in every sampling timing in series (S3), and comparing a size with a feature point power value Pj. If the last extracted power value of Pi is larger than the feature point power value Pj, then the feature point power value Pj is replaced with the power value of Pi (S7, S9). The elapsed time is reset to 0 when a new power value is replaced. Then, the process starts over from step S3 with a new feature power value Pj (S11).

On the other hand, if a larger power value of Pi is not found within a set time period T after a point wherein the feature point power value Pj is appeared (S13), then the extracted location and power value of the feature point power value Pj are recorded as a peak location and a peak value of the digest playback point (S15). A feature point power value Pj is reset to the initial state after the digest playback point is determined (S17, S1), and the process starts over from step S3.

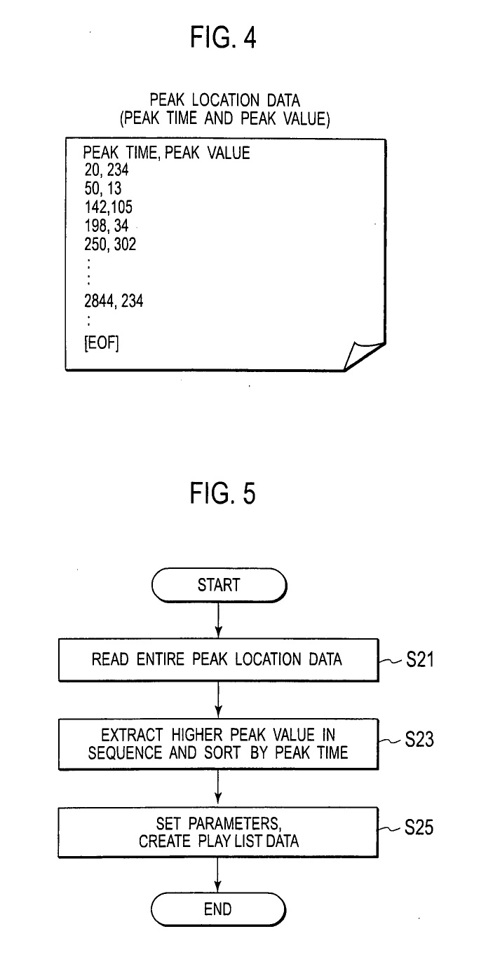

The above digest playback point recording process continues until a user stops the operation or an end (of the content) is reached. With this method, peak locations and peak values of a series of digest playback points for each content are recorded into storage device 16. FIG. 4 shows a list of peak locations and peak values of the group of the digest playback points that are recorded into storage device 16 as described in the process above.

Next, referring to FIG. 5, a digest playback process according to the embodiment in the video playback apparatus is explained. Playback controller 17 retrieves a group of digest playback points (a list shown in FIG. 4), which are stored in storage device 16, sorts the digest playback point in order from a highest peak value, and extracts a specified number of the digest playback points (S21, S23). Then, the extracted digest playback points are sorted in the original order. The extracted number(s) is an arbitrary number, and either the number of all the extracted digest playback points or the number of digest playback points that are replayed within a set time period also can be used.

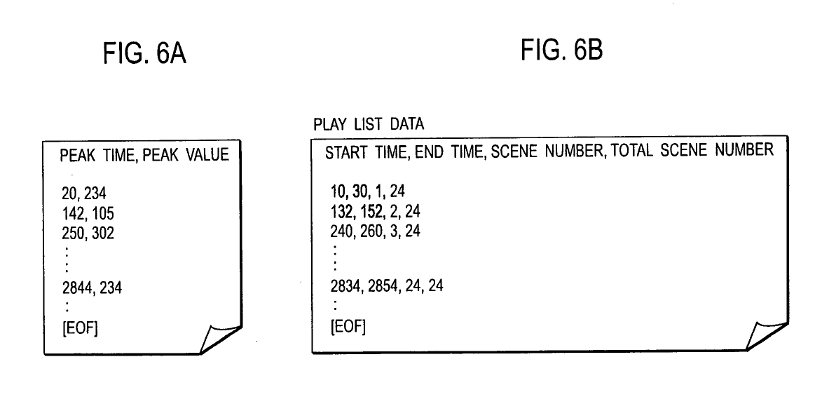

An example of the results from steps S21 and S23 is shown in FIG. 6A. From these results, a play list such as the example shown in FIG. 6B is created. The digest playback points extracted in S23 are listed on the play list in the original order they were recorded.

Playback controller 17 sets up a playback start location and a playback end location for digest scenes corresponding to digest playback points (S25). The Playback start location is placed in a set time period T before a specified peak location, and the playback end location is placed in a set time period T after a specified peak location. Furthermore, a cut-off playback time T of the digest scene is equal to the length of a peak search time T according to the embodiment. However, the length of the cut-off playback time is not limited to the embodiment. In addition, the information above is recorded into the play list with information about the total number of digest scenes and the playback order of the digest scenes by playback controller 17.

FIG. 6B shows an example in which the above set time period (playback period) T is defined as ten seconds and twenty four is indicated as the number of the digest playback points that have been extracted from the group of digest playback points. The first line of the play list indicates: 10 as the start time, 30 as the end time, 1 as the location number among the total digest playback points and 24 as the total number of the digest playback points.

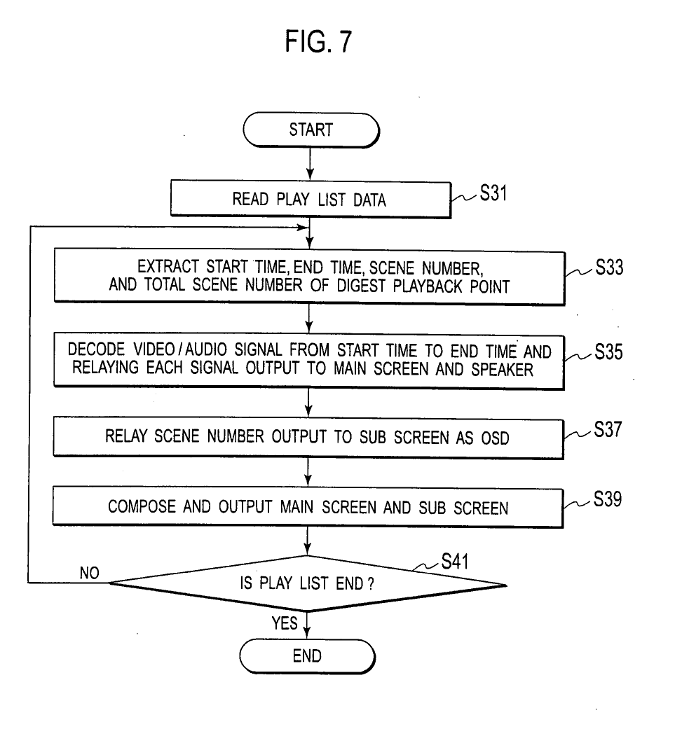

Next, playback controller 17 performs a playback process using the play list outlined in the flowchart of FIG. 7. The steps of the process by playback controller 17 include: sending a play list such as the list shown in FIG. 6B into ID information output unit 21, reading a recorded video signal within a set time period T from a specified location in a recorded order for content stored in storage device 16 based on the play list (S31, S33), and outputting the recorded video signal to AV decoder 18. The recorded video signal is decoded by AV decoder 18. The decoded video signal is sent to a main screen of monitor 19 for display, and the decoded audio signal is sent to speaker 20 for output (S35).

Also, ID information output unit 21 performs procedures that include: obtaining information of the total number of the digest scenes and a playback order of the digest scenes based on the entered play list, generating playback progress information that indicates a location of a digest scene currently being replayed from the entire digest scenes, and controlling output to display the information on a sub screen of monitor 19 as OSD (S37).

The playback audio signal decoded by AV decoder 18 is relayed to speaker 20, and the decoded video signal is relayed to monitor 19 with the playback progress information, which is indicated as OSD (S39). The digest playback process above continues until a user stops the operation or an end (of the content) is reached.

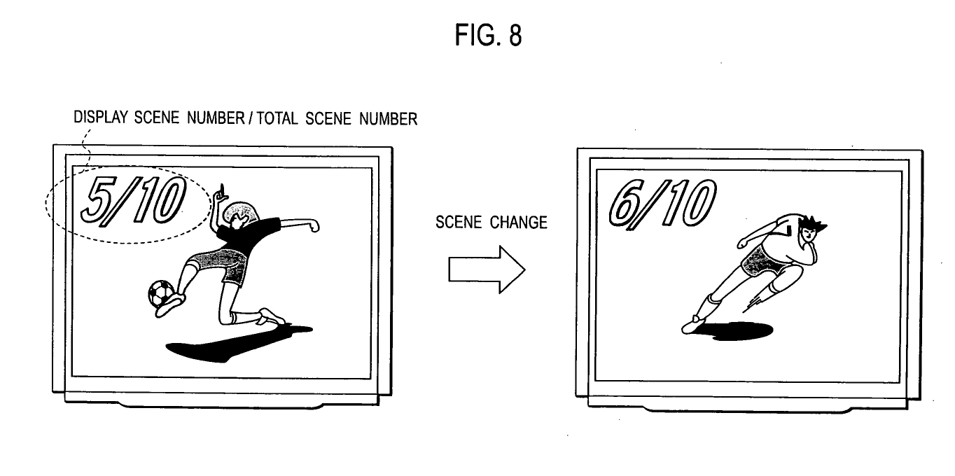

FIG. 8 through FIG. 10 are exemplary playback progress information displays for scene changes according to an embodiment. The current scene number and the total scene number are displayed as “Scene number/Total scene number” as shown in FIG. 8.

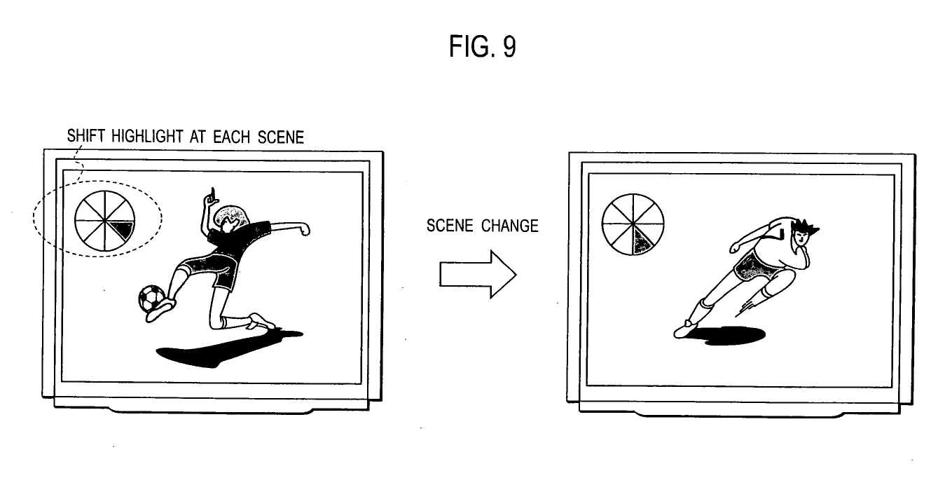

In FIG. 9, a circle that represents the entire digest scenes is divided by the total digest scene number, and a division circle corresponding to the digest scene currently being replayed is displayed and highlighted. The division circle can display the playback progress using a clockwise movement along the playback order of the digest scenes.

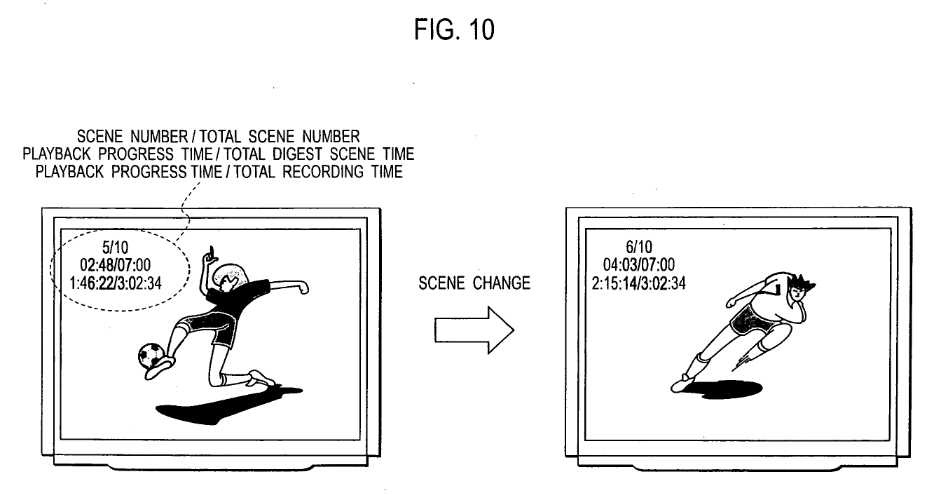

FIG. 10 shows a playback progress time in the total digest scene time being displayed with the total digest scene time as “Playback progress time/Total digest scene time” and a playback progress time in the total recording time being displayed with the total recording time as “Playback progress time/Total recording time,” in addition to the “Scene number/Total scene number.”

According to the embodiment above, more distinctive digest scenes of the recorded content in storage device 16 can be replayed from the beginning for as many numbers of scenes that can be replayed within the predetermined digest playback time. Also, even if the content has a long volume, highlighted scenes can automatically be replayed, and a playback progress in a scene change of digest playback can be indicated with a number such as the scene number of the scene currently being replayed. As a result, the playback progress and scene changes of the digest scenes can be easily recognized by a user, and searching for desired scenes can be easily performed. This can improve ease of consumer use. Especially, with a method of using the scene number and the total scene number of the digest scenes, displaying playback progress with a circle graph, and/or indicating playback progress time, a user can identify which feature scene is currently replayed in the entire feature scenes, which makes it easy for the user to replay digest scenes.

According to the embodiment above, a scene number of the feature scene currently replayed is displayed on the monitor to inform a user of the digest playback progress. However, the scene number can also be output with an audio sound from speaker.

In addition, digest playback point information regarding the peak is recorded into a storage device to determine digest playback points in the embodiment described above. However, without recording to the storage device, the determination also can be performed simultaneously with processing playback.

The embodiment described above provides a video playback apparatus that informs a user of scene changes.

The invention may be embodied in other specific forms without departing from the spirit or essential characteristics thereof. The embodiments therefore are to be considered in all respects as illustrative and not restrictive; the scope of the invention being indicated by the appended claims rather than by the foregoing description, and all changes that come within the meaning and range of equivalency of the claims are therefore intended to be embraced therein.

What is claimed is:

1. A video playback apparatus, comprising:
a feature extraction unit that extracts multiple feature scenes in audio/video content; and
a playback unit that replays one or more feature scenes that are extracted by the feature extraction unit;
wherein the playback unit comprises an identification information output unit that outputs information for identifying a feature scene being replayed.

2. The video playback apparatus as claimed in claim 1, wherein
the feature extraction unit includes a peak detector that detects an audio signal output peak, and
wherein the feature extraction unit extracts the feature scene by taking out a peak of the audio signal output detected by the peak detector.

3. The video playback apparatus as claimed in claim 2, wherein
the peak detector determines a detected output value of the audio signal at a recorded location as a peak value, when the output value at the location is the largest among the output value detected within a predetermined time.

4. The video playback apparatus as claimed in claim 1, wherein
the playback unit includes a playback controller that determines a playback order of the feature scenes that are extracted by the feature extraction unit, and
the identification information output unit outputs information about the playback order that is determined by the playback controller in order to identify a feature scene being replayed.

5. The video playback apparatus as claimed in claim 2, wherein
the playback controller selects a specified number of extracted feature scenes in order from a highest peak value and replays the selected feature scenes in their original order before extraction.

6. The video playback apparatus as claimed in claim 1, wherein
the information that identifies the feature scenes is a playback order of a feature scene being replayed in the entire set of feature scenes.

7. The video playback apparatus as claimed in claim 1, wherein
the information that identifies the feature scenes is playback progress of feature scenes.

8. The video playback apparatus as claimed in claim 7, wherein
the playback progress of feature scenes is displayed as a circle that represents the entire playback feature scenes divided by the total feature scene number, and wherein a division circle that corresponds to a feature scene being replayed is displayed and highlighted.

9. A video playback apparatus, comprising:
a display unit;
a feature extraction unit that extracts multiple feature scenes that comprise audio and video content; and
an identification information output unit that outputs identification information to the display unit for identifying the feature scenes extracted by the feature extraction unit,
wherein a feature scene and corresponding identification information of the feature scene are displayed on the display unit simultaneously.

10. The video playback apparatus as claimed in claim 9, wherein
the identification information is a playback order number of a feature scene being replayed in the entire set of feature scenes.

11. The video playback apparatus as claimed in claim 9, wherein
the identification information is playback progress of feature scenes.

12. The video playback apparatus as claimed in claim 11, wherein
the playback progress of feature scenes is displayed as a circle that represents the entire playback feature scenes divided by the total feature scene number, and wherein a division circle that corresponds to a feature scene being replayed is displayed and highlighted.

13. A video playback method, comprising:
obtaining an audio/video content;
extracting multiple feature scenes in the audio/video content based on their audio signals of the audio/video content; and
replaying the extracted feature scenes and indicating information that identifies the feature scenes.

14. The video playback method as claimed in claim 13, wherein
extraction of the multiple feature scenes is determined by detecting one or more peak of audio signal output within the audio/video content.

15. The video playback method as claimed in claim 14, wherein the extraction method comprises:
detecting a power value and its recorded location as a peak value and peak location of the audio signal output in the audio/video content if the power value is larger than other power values within a set time period after the power value appeared, and
extracting a feature scene by taking out the detected peak value and peak location.

16. The video playback method as claimed in claim 13, wherein the extracted feature scenes are replayed by determining a playback order of the feature scenes, and outputting information of the playback order that identifies a feature scene being replayed.

17. The video playback method as claimed in claim 14, wherein the extracted feature scenes are replayed by selecting a specified number of extracted feature scenes in order based on highest peak value, and replaying the selected feature scenes in their original order before extraction.

18. The video playback method as claimed in claim 13, wherein
the identification information is information about a playback progress of feature scenes.

19. The video playback method as claimed in claim 18, wherein
the playback progress of feature scenes is displayed as a circle that represents the entire playback feature scenes divided by the total feature scene number, and wherein a division circle that corresponds to a feature scene being replayed is displayed and highlighted.
